(19) United States
(12) Patent Application Publication
(10) Pub. No.: US 2014/0012833 A1
(43) Pub. Date: Jan. 9, 2014

(54) PROTECTION OF DATA PRIVACY IN AN ENTERPRISE SYSTEM

(71) Applicant: HANS-CHRISTIAN HUMPRECHT, Heidelberg (DE)

(72) Inventor: HANS-CHRISTIAN HUMPRECHT, Heidelberg (DE)

(21) Appl. No.: 14/024,628

(22) Filed: Sep. 11, 2013

Related U.S. Application Data
(63) Continuation-in-part of application No. 13/231,267, filed on Sep. 13, 2011.

(30) Foreign Application Priority Data
Sep. 11, 2012 (EP) 12183810.6

(51) Int. Cl. G06F 21/60

(52) U.S. Cl. CPC G06F 21/60
USPC 707/711; 707/706

(57) ABSTRACT

Various embodiments of systems and methods for protection of data privacy in an enterprise system are described herein. A data request is generated using an application. The data request is sent to a query engine and a database query is generated. A database is queried using the database query and a database response is generated. The database response is sent to the query engine. A blocking table is searched for an identifier in the database response. The blocking table comprises a listing of identifiers identifying tuples with one or more blocked attributes and a data overlay for redacting the one or more blocked attributes. The data overlay is substituted for the one or more blocked attributes in the database response if the identifier is found in the blocking table. After substituting, the database response is sent to the application.

### CROSS-REFERENCES TO RELATED APPLICATIONS

This application is a continuation-in-part application of U.S. patent application Ser. No. 13/231,267, filed Sep. 13, 2011. This application also claims the benefit of priority from European patent application No. 12183810.6, filed Sep. 11, 2012.

### FIELD

The field relates generally to data management systems. More particularly, the field relates to protection of data privacy.

### BACKGROUND

Enterprises typically maintain data of several entities such as employees, customers, and suppliers. This data is stored and can be used for several purposes such as for transactions, data collections, analytics and reporting. Some of the stored information can be sensitive or private and required to have access restrictions to comply with statutory data privacy regulations. The relationship between an entity and an enterprise may define the way privacy should be handled. For example, data of an ex-employee needs to be handled differently compared to data of existing employees. Data of an ex-employee may need to be deleted or restricted for limited access. Similarly, data of a barred supplier or a past customer may need to be handled differently compared to existing suppliers or customers. However, sensitive data may not be segregated and is typically stored along with other data. Applications that access stored data consider sensitive and non-sensitive data alike and may disclose sensitive data, leading to privacy issues.

It would therefore be desirable to protect sensitive data to comply with data privacy policies and regulations.

### SUMMARY

Various embodiments of systems and methods for protection of data privacy in an enterprise system are described herein. A data request is generated by an application operable to request and receive data from a query engine. The data request from the application is sent to the query engine. A database query is generated by the query engine using the data request. A database is then queried using the database query. A database response is then generated. The database response is sent to the query engine. A blocking table is then searched for an identifier in the database response. The blocking table comprises a listing of identifiers identifying tuples with one or more blocked attributes. The blocking table also comprises a data overlay for redacting the one or more blocked attributes. The data overlay is substituted for the one or more blocked attributes in the database response when the identifier is found in the blocking table. After substituting, the database response is sent to the application.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of an enterprise system environment, according to one embodiment.

FIG. 2 is a block diagram of a method for protecting data privacy in an enterprise system, according to one embodiment.

FIG. 3 is a block diagram of a user interface displaying a result of query to a database, according to one embodiment.

FIG. 4 is a block diagram of a process for defining a mask layout, according to one embodiment.

FIG. 5 is a block diagram of a scenario where data privacy is protected in an enterprise system environment, according to one embodiment.

FIG. 6 is a block diagram of an exemplary computer system according to one embodiment.

FIG. 7 is a block diagram of a method, according to one embodiment.

FIG. 8 is a block diagram illustrating a database system, according to one embodiment.

FIG. 9 is a block diagram illustrating a database system, according to another embodiment.

### DETAILED DESCRIPTION

Embodiments of techniques for protection of data privacy in an enterprise system are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

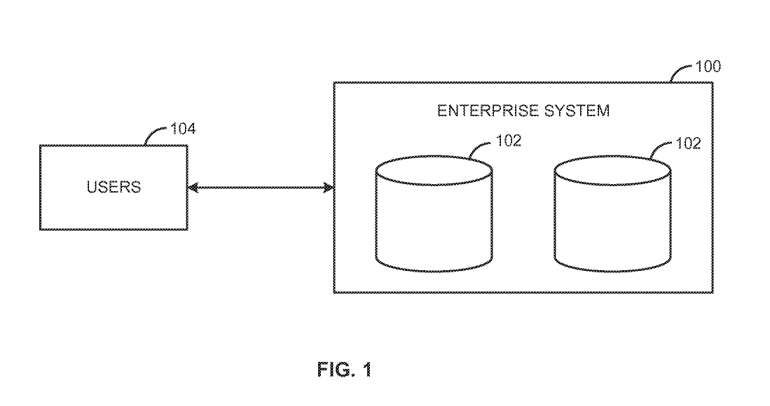

Referring to FIG. 1, an enterprise system 100 is commonly used for managing various functions of a business. Almost all business-related data such as financial data and data of suppliers, customers, and employees is stored in an electronic database 102 of the enterprise system 100. The data can be stored in more than one electronic database 102. In one embodiment, the enterprise system 100 is an Enterprise Resource Planning (ERP) system. Several users 104 access the enterprise system 100. The users 104 can be categorized depending on their role and responsibility, which can define the way the data can be accessed or what data can be accessed. For example, a user from a particular function of a business such as sales division has in-depth access to sales data but may not have ready access to data of other business functions. Similarly, a user from human resources division has access to employee data but may not have ready access to sales data. The users 104 also include a data or system administrator who plays a key role in managing and controlling access to data.

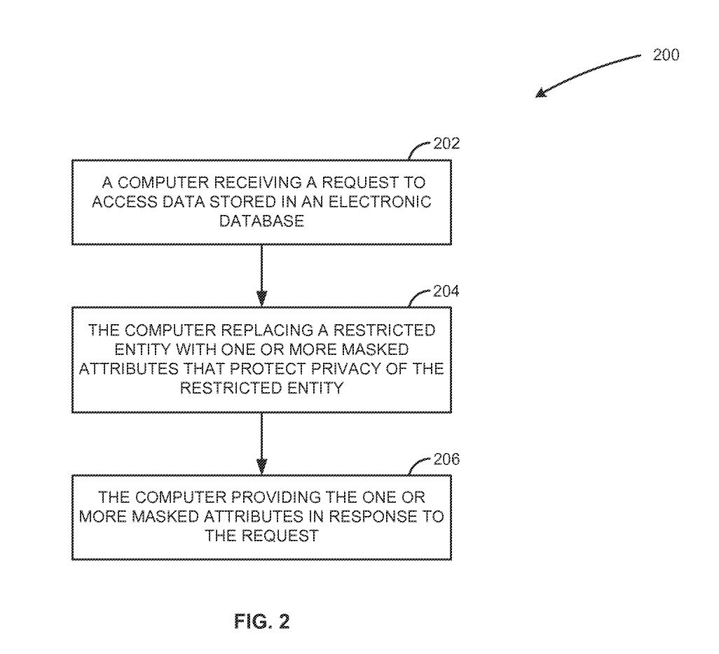

FIG. 2 illustrates an embodiment of a method 200 for protecting data privacy in an enterprise system. Various activities such as reporting, business analytics, business transactions, etc., require access to stored data. Typically, users access an enterprise application and select various options on a user interface to perform such activities. In response to user selections, at 202, a computer receives a request to access data stored in an electronic database. The request indicates what data is required and should be accessed based on the user selections.

The stored data, however, includes both restricted entities and unrestricted entities. An enterprise has relationship with several entities such as an employee, an individual, a customer, and a supplier. The relationship between the enterprise and the entity and a data privacy policy define the way data of the entity should be or will be handled. In one embodiment, the data privacy policy is a statutory policy for protecting data privacy. In another embodiment, the data privacy policy is a custom data privacy policy of the enterprise that is agreed by the entity and complies with the statutory data privacy policy.

Based on the data privacy policy, data of some entities can be sensitive and may not be accessed by all users. Access or viewing restrictions should be in place to protect privacy. Data of entities that should have access restrictions are called as restricted entities. For example, data of an ex-employee needs to have restrictions to prevent inadvertent viewing by a user of an enterprise application. A data privacy policy may require that the data of an ex-employee should be either deleted after formalities or restricted for limited access. Whereas data of existing employees can be viewed by any authorized user, e.g., a human resource professional. Therefore, data of the ex-employee is a restricted entity and data of an existing employee is an unrestricted entity. Similarly, data of a supplier or a customer with whom the enterprise no longer maintains a relationship may need to be protected as per data privacy clauses in an agreement. Such data which needed to be protected is categorized as restricted entities. Data of current suppliers or customers fall into the category of unrestricted entities and can be accessed by any authorized user.

At 204, if the request requires accessing restricted entities, the restricted entities are replaced with one or more masked attributes. These masked attributes are such that they protect the privacy of the restricted entity. For example, a masked attribute can be a word such as “customer blocked” or “blocked user.” A masked attribute can be any combination of letters that indicates that the entity is restricted and its information cannot be viewed. To replace a restricted entity an attribute, a system admin should define a mask layout for the restricted entity as soon as an entity is classified as a restricted entity as per a data privacy policy. The mask layout includes one or more masked attributes that conceal the identity or other information of the restricted entity. These masked attributes are assigned to attributes of a restricted entity. For example, the attributes of an ex-employee includes name and other dependant information such as contact information, date of birth, tenure, etc. The system admin defines masked attributes for the attributes of the ex-employee. In one embodiment, a single masked attribute such as “blocked user” can be defined for all the attributes or for the restricted entity as a whole. So whenever there is a request to access data of the ex-employee (e.g., one or more attributes of the ex-employee), the data of the ex-employee is replaced with the masked attribute “blocked user.”

As an example, consider that a utility company maintains data of its customers using an enterprise system. Information related to customers can be stored in an electronic database in a plurality of tables. Example of some tables “ORD” and “CUST” are presented below:

ORD

| ID | NAME | ARTICLE |
|---|---|---|
| 1 | Name 1 | 4711 |
| 2 | Name 2 | 4711 |
| 3 | Name 3 | 4712 |
| 4 | Name 4 | 4772 |
| . | . | . |
| 17 | Name 17 | 4713 |
| . | . | . |
| n | Name n | 4788 |

CUST

| ID | NAME | ADDRESS |
|---|---|---|
| 1 | Name 1 | Street . . . |
| 2 | Name 2 | Street . . . |
| 3 | Name 3 | Street . . . |
| 4 | Name 4 | Street . . . |
| . | . | . |
| 17 | Customer 17 | Street . . . |
| . | . | . |
| n | Customer n | Street . . . |

The ORD table is a table to store product order details of the customers. The ORD table includes a customer ID column, a customer name column, and an article column for product codes or identifiers. The CUST table stores details of all customers. The details include attributes of customers such as name and address. Consider that the utility company is not doing business with some customers 1, 2, and 17. The private information of customers 1, 2, and 17 may need to be restricted or deleted sometime in the future. A table “CUST_B,” as shown below, can be used to define a mask layout.

CUST_B

| ID | NAME | NAME_B | STATUS |
|---|---|---|---|
| 1 | Name 1 | Customer blocked | 0 |
| 2 | Name 2 | Customer blocked | 1 |
| 17 | Name 17 | Customer blocked | 1 |

The CUST_B table stores details of customers who need to be restricted. The CUST_B table includes a NAME_B column which stores masked attributes with respect to the attributes (i.e. names) of the customer. The mask layout also includes statuses for replacing the restricted entity with a masked attribute. The CUST_B table includes a status column for defining the statuses for the restricted entities. As an example, a status ‘1’ for a customer indicates that the customer is in a blocking period, meaning that the customer data or attribute (e.g., name) should be replaced with the masked attribute “Customer blocked”. A status ‘0’ for a customer indicates that the blocking period for that customer has not yet started. A system administrator or a person responsible for data protection defines these statuses and also adds or deletes customers from CUST_B table based on a data privacy policy.

With a defined masked layout in place, after a request is received, the restricted entities which are in the CUST_B table and have status ‘1’ are replaced with corresponding masked attributes. The masked attributes along with any unrestricted entities are provided to the user at 206. In one embodiment, a filter is used to replace the restricted entities. The following statement in Structured Query Language (SQL) syntax shows an example of a filter that replaces a restricted entity.

```
SELECT
      Ord.ID,Article,Adress
CASE
      WHEN Status = 1 THEN Name_b ELSE Name
END
      AS Masked_Name
FROM
      Ord INNER JOIN Cust
ON
      Ord.ID = Cust.ID LEFT OUTER JOIN Cust_b
ON
      Ord.Name = Cust_b.Name
```

The filter is an SQL query for presenting data while replacing the restricted entities. The SQL query is generated in response to a user operation. The SELECT statement selects data from tables that are stored in the database. The result from the select statement is stored in a result-set. The SQL CASE statement is used to manipulate the presentation of data without updating or changing the data in a table and the value of the field “Masked_Name” depends on the CASE statement. The SQL JOIN clauses enable to select data from a plurality of tables. When the status column for a customer in CUST_B table is ‘1,’ the name of that customer is replaced with a masked attribute that is in the CUST_B table.

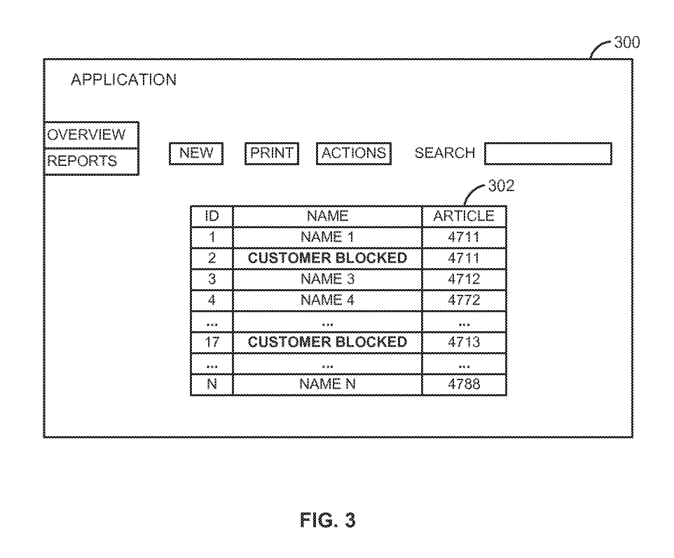

Referring to FIG. 3, the result list of the above SQL query is presented on a user interface 300 of an enterprise application. The result list 302 includes unrestricted entities such as names of customers 1, 3 and 4 and masked attributes (customer blocked) of the restricted entities, i.e. customer 2 and 17. Since the status of customer ‘1’ is set to ‘0,’ in one embodiment, it is not fully qualified as a restricted entity for data privacy protection and therefore displayed without any masked attributes.

The above-described approach can be applied to several scenarios. For example, the approach can be applied to employees of an organization. A table such as Employee_B can be created for restricted entities to define a masked layout. The restricted entities are ex-employees who left the organization or employees who are about to leave the organization. Masked attributes such as “Blocked User” or “Data restricted” can be assigned to the restricted entities. Similar approach can be used for suppliers or any other entity whose data is stored in the database of an enterprise system.

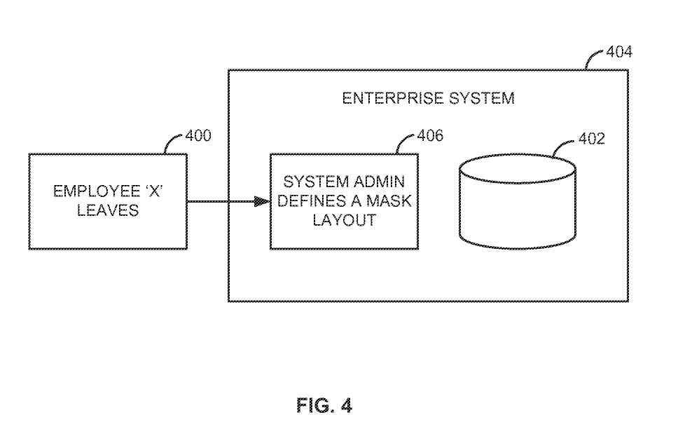

FIG. 4 illustrates an embodiment of a process for defining a mask layout in a business environment. When an entity such as an employee leaves 400 an organization, a system administrator is notified. Data of the employees is stored in an electronic database 402 of an enterprise system 404. In one embodiment, the enterprise system 404 is an on-premise system situated in one of the premises of the organization. The system administrator then defines a mask layout 406 for that employee in the enterprise system 404 by creating a table for defining the mask layout or by adding that employee in an existing table for defining the mask layout as described previously.

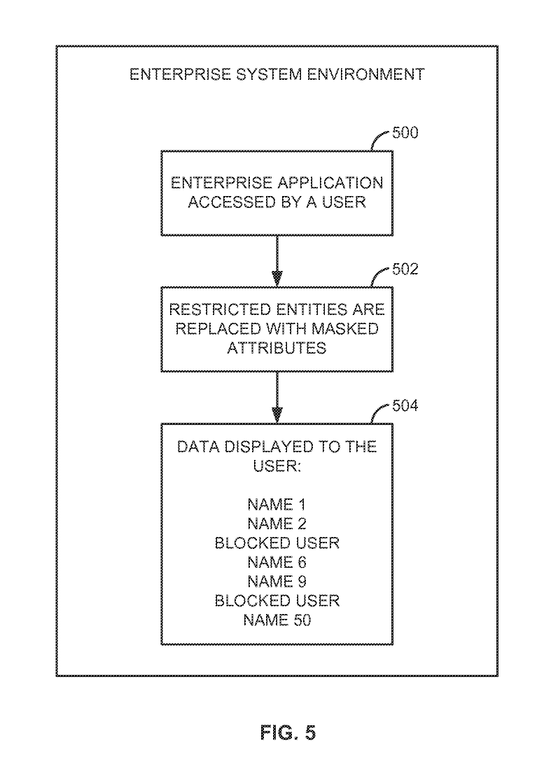

Referring to FIG. 5, several users of the organization use enterprise applications for various purposes. A user accesses an enterprise application 500 and selects various options to access data. A request for data is then created following user selections. If the requested data includes restricted entities for which a system administrator defined a masked layout, as described in reference to FIG. 4, then the restricted entities are replaced with masked attributes 502. Data is then displayed to the user. The displayed data includes unrestricted entities and masked attributes of the restricted entities. For unrestricted entities, attributes such as names (e.g., Name 1, Name 2, etc) and other dependant data are displayed. As described previously, masked attributes can include “Blocked User” or other characters that are defined by the system administrator in the mask layout.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

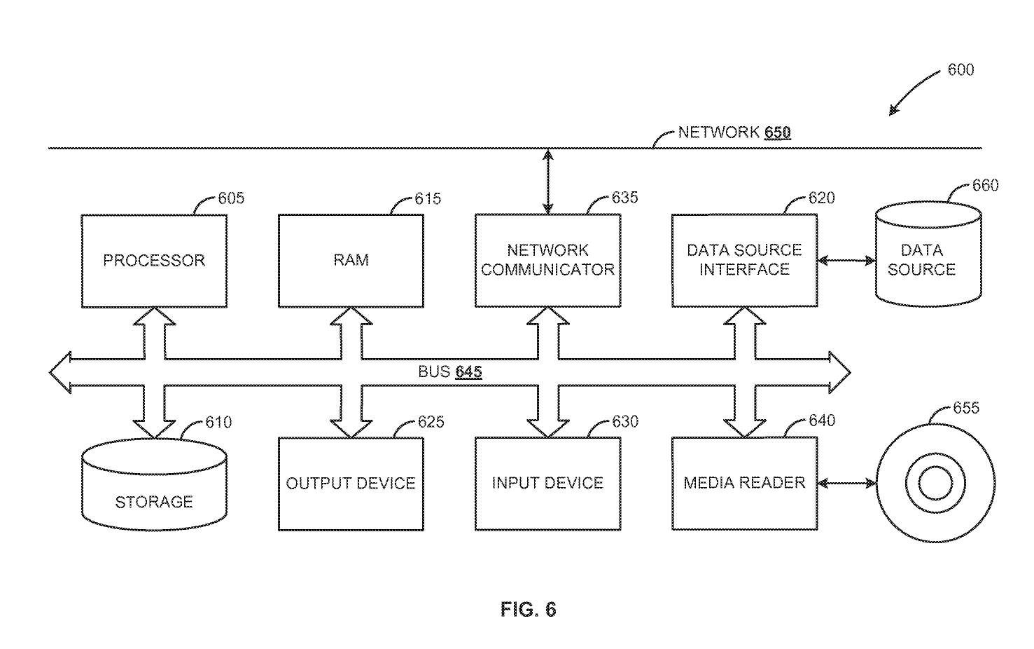

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

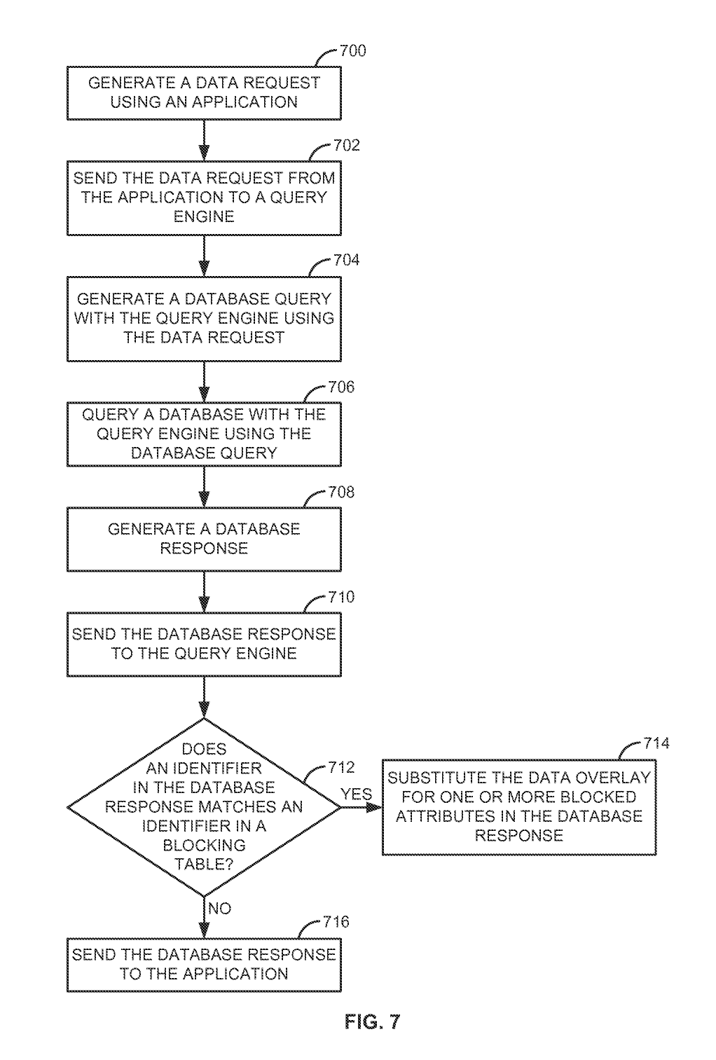

FIG. 7 shows a flow diagram illustrating a method according to an embodiment. At 700, a data request is generated using an application. Next at 702, a data request is sent from the application to the query engine. This may be across a network or it may be performed internally within one computer system. Next at 704, a database query is generated by the query engine using the request. Next at 706, a database, e.g. a relational database, is queried by the query engine using the database query. This may also be performed within a single machine or across a network depending upon a particular embodiment. Next at 708, a database response is generated using the database query.

At 710, the relational database sends the database response to the query engine. At 712, a determination of whether an identifier in the database response matches an identifier in a blocking table. A blocking table includes a listing of identifiers identifying tuples with one or more blocked attributes. The identifiers are used to identify a particular data record or records which are related to a specific entity or individual. For instance, the identifiers may be a name, an employee number, a part number, or other reference. The blocking table further comprises a data overlay for redacting the one or more blocked attributes. In one embodiment, data overlay may refer to a mask layout and blocked attributes may refer to masked attributes. A tuple comprises a number of attributes and if the tuple is identified as being listed in the blocking table then the data overlay may be used to replace that data within the tuple. The data overlay specifies data that will be replaced or overwritten.

If an identifier in the database response matches an identifier in the blocking table, then the method proceeds to 714. At 714, the data overlay is substituted for one or more blocked attributes in the database response. This effectively redacts the one or more blocked attributes. Then the method proceeds to 716 and the database response is sent to the application. If at 712 an identifier in the database response is not found in the blocking table, then the method proceeds directly to 716 and the database response is sent to the application. In this branch there is no redaction of attributes in the database response.

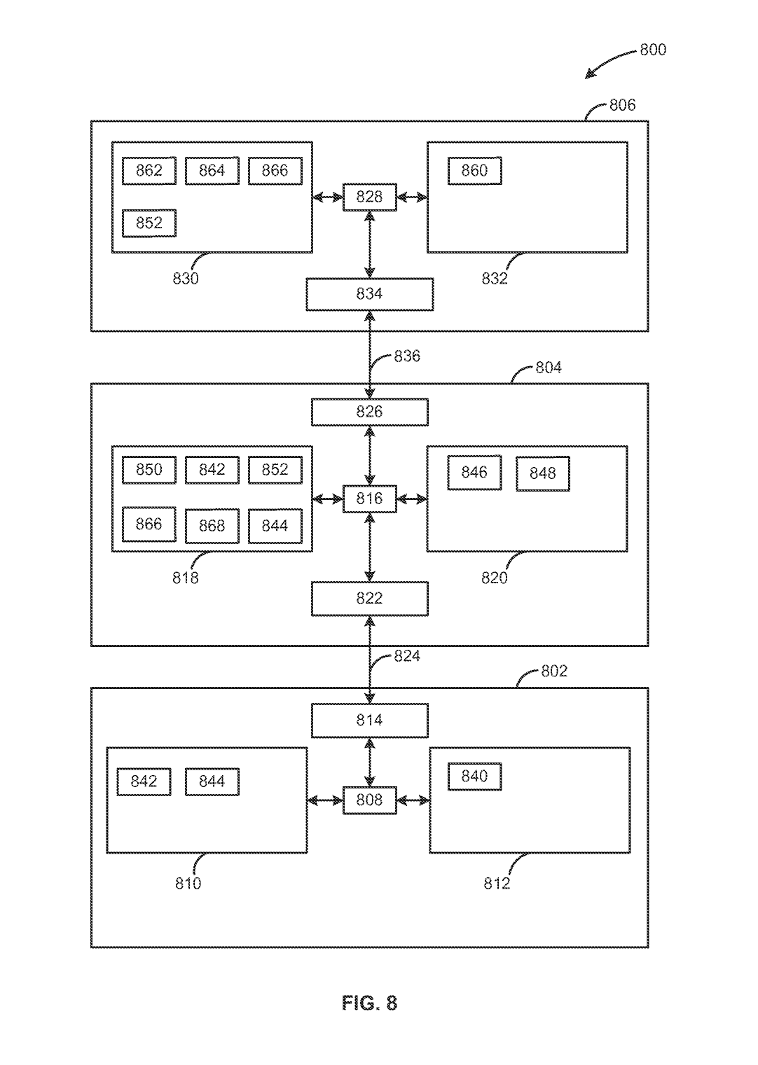

FIG. 8 illustrates a database system 800 according to an embodiment of the invention. In this embodiment there are three computers shown, an application server 802, a query engine server 804, and a database server 806. The use of three different computers is purely for the purpose of illustration. In some embodiments there may be more computers that are used or also in some embodiments there may be a single computer may implement the entire database system. In this example, the application server 802 comprises a processor 808 that is connected to a computer storage 810 and a computer memory 812. A processor 808 is further able to communicate with a network adaptor 814.

The query engine server 804 also comprises a processor 816. The processor 816 is connected to a computer storage 818 and a computer memory 820. The processor 816 is further connected to network adaptors 822 and 826. The network adaptor 822 and network adaptor 816 are used to form a first network connection 824. This enables data to be shared between the application server 802 and the query engine server 804.

The database server 806 is shown as also containing a processor 828. The processor 828 is connected to computer storage 830 and computer memory 832. The processor 826 is also connected to a network adaptor 834. The network adaptor 834 and 826 are shown as forming a second network connection 836. In some embodiments the network adaptor 822 and 826 may be identical.

The computer memory 812 of the application server 802 is shown as containing an application 840. The application may be any application which uses data from the database to perform a function or operation. The application may be automated or the application may be manually operated to request and received data. The application 840 is able to generate a data request 842. A copy of the data request 842 is shown in the computer storage 810. The computer storage 810 also shows a redacted database response 844 which was received from the query engine server 804.

The query engine server 804 has a memory 820 which is shown as containing a query engine 846 and code which modifies the query engine 848. The code 848 contains code 816 which modifies the query engine 846 to use the blocking table 850. The query engine 846 receives the data request 842 and generates a database query 852. The database query 852 is shown as being stored in the computer storage 818. The database query 852 is then used by the query engine 846 to query the database server. The memory 832 of the database server 806 is shown as containing code for implementing a relational database 860. The computer storage 830 shows a database table A 862 and database table B 864. These are the database tables used by the relational database 860.

The computer storage 830 is also shown as containing the database query 852 received from the query engine server 804. The relational database 860 then uses the database query 852 to retrieve data from the database tables 862, 864 and generate the database response 866. The database response 866 is then passed back to the query engine server 804. A copy of the database response 866 is shown in the computer storage 818. The modified code 848 is then used to compare the database response 866 to the blocking table 850. If an identifier is found then the modified code 848 uses a data overlay 868 to redact a portion of the database response 866. This generates the redacted database response 844. A copy of the redacted database response 844 is shown in computer storage 818. The query engine server 804 then sends this to the application server 802. The application 840 may then respond to the redacted database response 844.

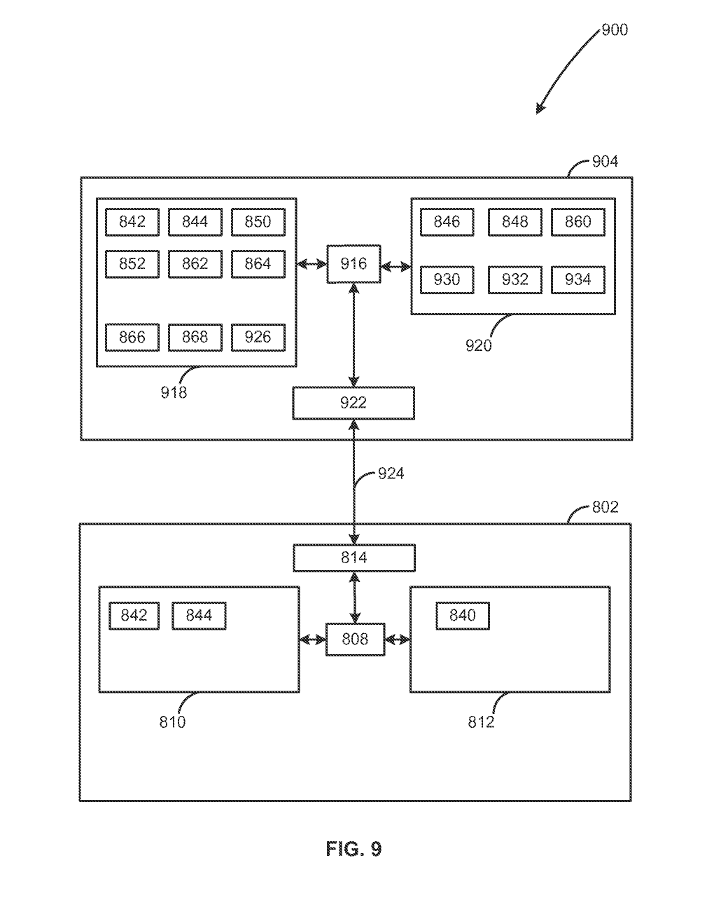

FIG. 9 shows a block diagram illustrating a further embodiment of a database system 900. The database system 900 is similar to the database system shown in FIG. 8. In this embodiment the database server 806 and query engine server 804 of FIG. has been combined into a single server 904.

The server 904 comprises a processor 916 connected to a network connection 922, a computer storage 918, and computer memory 920. The database system 900 may also be implemented by more or fewer computers.

The server 904 also comprises a processor 916. The processor 916 is connected to a computer storage 918 and a computer memory 920. The processor 916 is further connected to network adaptors 922. The network adaptor 922 and network adaptor 816 are used to form a network connection 924. This enables data to be shared between the application server 802 and the server 904.

The computer memory 920 and its contents is equivalent to the computer memories 820 and 832 in FIG. 8. The computer storage 918 and its contents are equivalent to the computer storage 818 and 830 in FIG. 8. Instead of data being shared across network connection 836 between servers 804 and 806, data is shared internally within server 904.

The computer storage is shown as containing an allowed access table 926 which contains a listing of allowed identity tokens. An identity token as used herein is any data or identifier which may be used to identify and/or verify the legitimacy of a data request to bypass the redaction caused by the blocking table. For instance, the identity token could be a user identification. This could be for instance a login name or an origin of the request. The identity token may also be a password and/or a user and password pair to provided controlled access. The identity token may also a cryptographic key. The identity token may also be a cryptographic signature. For instance the data request may be signed and the identity token may be part of a cryptographic key pair which verifies the signature. The use of a cryptographic key or a cryptographic signature may be beneficial because it provides verification of the access to the database system independent of how secure the database system is.

The identity tokens are used to indicate the origin of specific data requests which by pass the data overlay process. The step of substituting the data overlay for the one or more attributes in the database response is skipped if an identity token associated with a data request is found in the allowed access table 926.

The computer memory 920 is shown as further containing several elements such as a search index generation module 930, a blocking table search index 932, and an allowed token search index 934. The search index generation module 930 contains computer executable code which enables the processor to generate search indexes. The blocking table search index 932 enables fast searching of the blocking table 850 and the identity token search index enables fast searching of the allowed access table 926. The search index generation module 930 uses the blocking table 850 to construct the blocking table search index 932. The search index generation module 930 generates the allowed token search index 934 using the allowed access table 926.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A database system comprising:
a relational database comprising at least one data table;
a query engine for performing queries to the relational database;
a memory for storing machine executable instructions for implementing the database system; and
a processor for executing the machine executable instructions, wherein execution of the instructions cause the processor to:
generate a data request using an application operable to request and receive data from the query engine;
send the data request from the application to the query engine;
generate a database query with the query engine using the request;
query the database with the query engine using the database query;
generate a database response using the database query;
send the database response to the query engine;
search in a blocking table for an identifier in the database response, wherein the blocking table comprises a listing of identifiers identifying tuples with one or more blocked attributes, wherein the blocking table further comprises a data overlay for redacting the one or more blocked attributes;
substitute the data overlay for the one or more blocked attributes in the database response if the identifier is found in the blocking table; and
after substitution, send the database response to the application.

2. The database system of claim 1, wherein execution of the instructions further cause the processor to construct a blocking table search index using the blocking table, wherein the search for an identifier selected from the listing of identifiers in the database response uses the blocking table search index.

3. The database system of claim 2, wherein the data request comprises an identity token, wherein the database system further comprises an allowed access table comprising a listing of allowed identity tokens, wherein execution of the instructions further causes the processor to compare the identity token to the listing of allowed identity tokens.

4. The database system of claim 3, wherein the identity token comprises one or more of a user identification, a password, a cryptographic key, a cryptographic signature, and combinations thereof.

5. The database system of claim 4, wherein the wherein execution of the instructions further cause the processor to construct an allowed token search index, wherein the comparison of the identity token to the listing of allowed identity tokens is performed using the allowed token search index.

6. The database system of claim 1, wherein the database system comprises a first network connection between the application and the query engine, wherein the data request is sent across the first network connection, and wherein the database response is sent across the first network connection.

7. The database system of claim 1, wherein the database system further comprises a second network connection between the query engine and the relational database, and wherein the database is queried using the second network connection, and wherein the database response is sent to the query engine using the second network connection.

8. The database system of claim 1, wherein the data overlay is defined based on a data privacy policy.

9. The database system of claim 8, wherein the blocked attributes comprise a name and dependent data.

10. An article of manufacture including a non-transitory computer readable storage medium to tangibly store instructions, which when executed by a computer, cause the computer to:
generate a data request using an application operable to request and receive data from a query engine;
send the data request from the application to the query engine;
generate a database query with the query engine using the request;
query a database with the query engine using the database query;
generate a database response using the database query;
send the database response to the query engine;
search in a blocking table for an identifier in the database response, wherein the blocking table comprises a listing of identifiers identifying tuples with one or more blocked attributes, wherein the blocking table further comprises a data overlay for redacting the one or more blocked attributes and the data overlay is defined based on a data privacy policy;
substitute the data overlay for the one or more blocked attributes in the database response if the identifier is found in the blocking table; and
after substitution, send the database response to the application.

11. The article of manufacture of claim 10 further comprises instructions which when executed by a computer, cause the computer to:
construct a blocking table search index using the blocking table, wherein the search for an identifier selected from the listing of identifiers in the database response uses the blocking table search index.

12. The article of manufacture of claim 11 further comprises instructions which when executed by a computer, cause the computer to:
compare an identity token to a listing of allowed identity tokens in an allowed access table, wherein the data request comprises the identity token.

13. The article of manufacture of claim 12, wherein the identity token comprises one or more of a user identification, a password, a cryptographic key, a cryptographic signature, and combinations thereof.

14. The article of manufacture of claim 13 further comprises instructions which when executed by a computer, cause the computer to:
construct an allowed token search index, wherein the comparison of the identity token to the listing of allowed identity tokens is performed using the allowed token search index.

15. The article of manufacture of claim 10, wherein the blocked attributes comprise a name and dependent data.

16. A method of operating a database system, comprising:
generating a data request using an application operable to request and receive data from a query engine;
sending the data request from the application to the query engine:
generating a database query with the query engine using the request;
querying a database with the query engine using the database query;
generating a database response using the database query;
sending the database response to the query engine;
searching in a blocking table for an identifier in the database response, wherein the blocking table comprises a listing of identifiers identifying tuples with one or more blocked attributes, wherein the blocking table further comprises a data overlay for redacting the one or more blocked attributes and the data overlay is defined based on a data privacy policy;
substituting the data overlay for the one or more blocked attributes in the database response when the identifier is found in the blocking table; and
after substituting, send the database response to the application.

17. The method of claim 16, further comprising:
constructing a blocking table search index using the blocking table, wherein the search for an identifier selected from the listing of identifiers in the database response uses the blocking table search index.

18. The method of claim 17, further comprising:
comparing an identity token to a listing of allowed identity tokens in an allowed access table, wherein the data request comprises the identity token.

19. The method of claim 18, wherein the identity token comprises one or more of a user identification, a password, a cryptographic key, a cryptographic signature, and combinations thereof.

20. The method of claim 19, further comprising:
constructing an allowed token search index, wherein the comparison of the identity token to the listing of allowed identity tokens is performed using the allowed token search index.
